(19) United States
(12) Patent Application Publication
(10) Pub. No.: US 2024/0008503 A1
(43) Pub. Date: Jan. 11, 2024

(54) ANALOG CHEESE HAVING HIGH PROTEIN CONTENT AND METHODS OF MANUFACTURE

(71) Applicant: CORN PRODUCTS DEVELOPMENT, INC., Westchester, IL (US)

(72) Inventors: Indumathi Kangampalayam PALANISWAMY, Bridgewater, NJ (US); Matthew YURGEC, Bridgewater, NJ (US)

(21) Appl. No.: 18/246,057

(22) PCT Filed: Oct. 5, 2021
(86) PCT No.: PCT/US2021/053480

§ 371 Date: Mar. 21, 2023

Related U.S. Application Data
(60) Provisional application No. 63/088,236, filed on Oct. 6, 2020.

(51) Int. Cl. A23C 20/02; A23L 29/00

(52) U.S. Cl. CPC A23C 20/025; A23L 29/06

(57) ABSTRACT

The technology disclosed in this specification pertains to high protein analog cheese and methods of making such analog cheese. More specifically, such analog cheese comprises a crosslinked plant protein and may have a hardness of greater than 3,000 g without adding gums, fibers, or starches. As described in this specification are analog cheese masses useful for making an analog cheese.

The technology disclosed in this specification pertains to high protein analog cheese and methods of making such analog cheese. More specifically, such analog cheese comprises a crosslinked plant protein.

Analog cheese, as used in this specification, is a non-dairy food composition intended to mimic a dairy cheese. The described analog cheeses include a plant-based protein source and other ingredients which, when combined, are intended to provide the functionality of dairy cheese. Analog cheese commonly has low protein content compared to dairy cheese largely because of the difficulty inworking with plant-based proteins. For example, plant-based proteins are not easy to form into a pressable or cuttable curd using common dairy cheese making processes like use of acid or rennet or CaCl₂) and mixtures thereof. So it is common for analog cheese to include starch, hydrocolloid, fibers, and other texturizing agents to produce the analog cheese mass.

The technology disclosed in this specification pertains to analog cheese and methods for making a high protein analog cheese. In embodiments, an analog cheese is made using transglutaminase and pulse protein to make a mass that loses moisture through synereses to form a gel that can be cut and pressed, like in conventional cheesemaking process, to yield a cheese-like mass. In at least some embodiments the analog cheese is made for form a cheese-like mass without the use of additional modified starch, hydrocolloids, fibers or, other texturizing agent.

The technology disclosed in this specification can be further understood with references to the following figures, which are provided for illustrative purposes only and are not intended to limit the full scope of the disclosure.

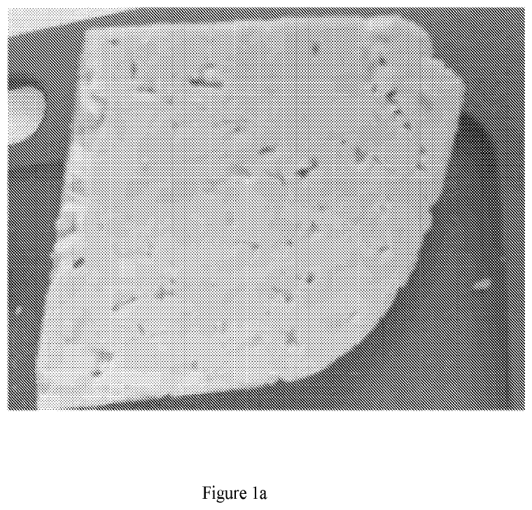

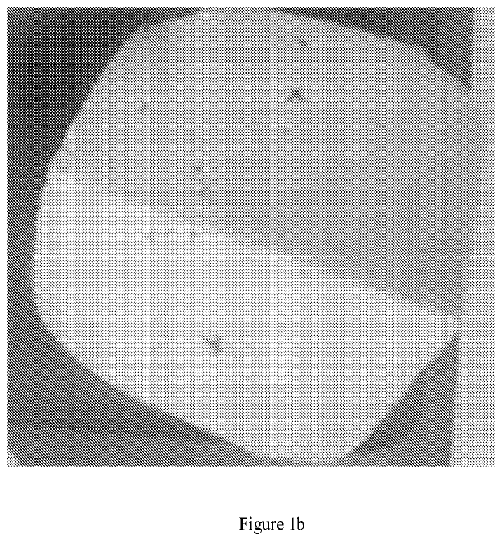

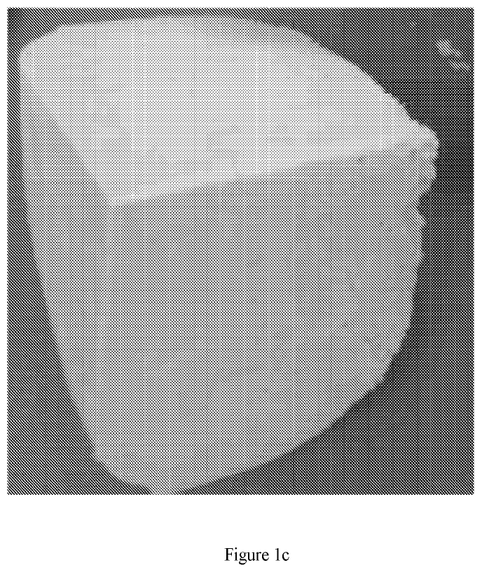

FIG. 1, provides three photographs (FIGS. 1A, 1B, and 1C), which depict embodiments of an analog cheese subjected to different bromelain treatments. FIG. 1A has no bromelain, FIGS. 1B and 1C were treated with bromelain for different times before the bromelain was inactivated using heat.

In any embodiment, this specification discloses an analog cheese comprising fat and a crosslinked plant-based protein. In any embodiment described in this specification, an analog cheese has a protein content of from about 5 g to about 7 g per 28 gram serving.

In various aspects, an analog cheese, as described in this specification is crosslinked using a transglutaminase in order to increase the firmness or hardness of the analog cheese. In various other aspects, an analog cheese as described in this specification is treated with a protease, such as bromelain or papain, to soften, tenderize, or otherwise change the texture of an analog cheese compared to an analog cheese not treated with a protease. In embodiments, an analog cheese as described in this specification has hardness of from about 3000 g to about 14,000 g. In some embodiments, analog cheese using only transglutaminase or using transglutaminase and a protease during analog cheese mass formation has a hardness of about 8,000 g to about 14,000 g, or from about 9,000 g to about 12,000 g. In other embodiments described in this specification, an analog cheese treated with a transglutaminase during analog cheese mass formation and further treating the formed cheese mass with protease has a hardness of about 3,000 g to about 7,000 g, or from about 4,000 g to about 6,000 g.

In embodiments of an analog cheese described in this specification, protein content, use of transglutaminase, use of protease enzymes and order of adding enzymes can be balanced to obtain analog cheeses of various hardnesses. Various illustrative observations are now provided for analog cheese allowed to rest, akin to ripening for dairy cheeses. Note however, that although use of starter cultures, glucono delta-lactone or bromelain, or mixtures thereof, induces some ripening like effects, the analog cheese does not truly ripen in the sense of a dairy cheese. Analog cheeses using transglutaminase, but not bromelain, were harder (about 10,000 g) than analog cheeses using transglutaminase followed by adding bromelain to a formed cheese mass (about 5,000 g). Additionally, analog cheeses made using transglutaminase followed by adding bromelain to the formed cheese mass had a more homogenous, cheese-like appearance that analog cheese that do not use bromelain. For analog cheeses where bromelain was added to the mass (0.5, 1.0 or 2.0 hours) and deactivated and then transglutaminase was added, the analog cheese was slightly harder than analog cheeses using only transglutaminase (about 11,000 g). But analog cheese where bromelain was added to the mass (0.5, 1.0 or 2.0 hours) and deactivated and then transglutaminase was added, the analog cheese had an appearance like analog cheeses made using bromelain after transglutaminase. With reference to FIGS. 1A, 1B, and 1C it is seen that FIG. 1A, an analog cheese made with transglutaminase but without bromelain, has a less homogenous appearance than the analog cheese of either FIG. 1B or FIG. 1C, which both use bromelain. FIG. 1B had a 0.5-hour bromelain treatment and FIG. 1C had a 1.0-hour bromelain treatment.

In various embodiments of an analog cheese, plant-based proteins are pulse proteins. In various embodiments, a plant-based protein is a pea protein, a mung bean protein, a fava bean protein, a lentil protein, a chickpea protein or a potato protein or mixture thereof. In any embodiment an analog cheese, as described in this specification, comprises a mixture of plant-based proteins. Use of mixtures includes mixtures of pea protein and fava bean protein or mixtures of pea protein and mung pea protein or mixtures or pea protein and potato protein, or mixtures of pea protein and fava bean protein and potato protein.

In any embodiment described in this specification, an analog cheese uses any suitable plant-based oil, including but not limited to coconut oil, palm, oil, sunflower oil, canola oil, vegetable oil, and mixtures thereof.

In some embodiments additional texturizing ingredients may be used to further adjust the hardness of the analog cheese. Common texturizing agents include starch, in native, pregelatinized, and modified forms. Starch may be from any botanical starch, including but not limited to corn, tapioca, potato, pea, rice, sago, chickpea, lentil, fava bean, quinoa including high and low (or waxy) amylose variants. Starch may be provided as starch, or as a flour, including flours processed to have high protein content relative to the unprocessed flour. Starches and flours may be hydrolyzed or thinned to improve gelling properties for example by shear, acid hydrolysis, oxidation, oxidative hydrolysis, enzymatic hydrolysis. Starch may also be modified to improve process tolerance such as by etherification or esterification or thermal inhibition. Examples of modified starch further include phosphate crosslinked starch, adipate crosslinked starch, hydroxypropylated starch, acetylated starch, starch citrates, and succinate modified starch including octenylsuccinate (OSA) modified starches.

Other common texturizing agents include hydrocolloids including gums and fibers including but not limited to xanthan gum, guar gum, acacia gum, locust bean gum, carrageenan, pectin, agar, modified celluloses such as carboxymethylcellulose (CMC) or hydroxypropylmethylcellulose (HPMC).

An important attribute of the technology disclosed in this specification is the ability to make high-protein, hard cheese without the use of starch, hydrocolloid, fiber, and mixtures thereof. As such in any embodiment disclosed in this specification, analog cheese does not comprise an added starch, hydrocolloid, fiber or mixture thereof.

In various embodiments, analog cheese, as described in this specification includes a ripening agent, which, for example may be, glucono delta-lactone or starter culture. In various embodiments, a starter culture useful for making an analog cheese comprises an acid forming bacteria, or a lactic acid forming bacteria. In various embodiments a starter culture comprises one or more bacteria species including but not limited to Streptococcus thermophilus, Lactobacillus bulgaricus, Lactobacillus acidophilus, Lactobacillus paracasei, and Bifidobacterium animalis and mixtures thereof.

Analog cheese, as described in this specification may also include, salts, acidulants and other flavoring ingredients commonly used in analog cheese.

In any embodiment, this specification discloses an analog cheese having fat in an amount of from about 20% to about 30% (wt % of the analog cheese), or from about 23% to about 26%; plant-based protein in an amount of from about 15% to about 25% (wt % of the analog cheese), or from about 18% to about 21%; and transglutaminase in an amount of from about 0.40% to about 0.60% (wt % of the analog cheese), or from about 0.45 to about 0.55%, or from about 0.48% to about 0.51%. In any embodiment described in this specification, an analog cheese further comprises a bromelain in an amount up to about 0.85% (wt % by weight of the analog cheese), or from about 0.75% to about 0.85%, or from about 0.77% to about 0.83%. In any embodiment, bromelain is provided by use of a non-flavored meat tenderizing agent.

Within the described range of plant-based protein a mixture may use all proteins equally or use a majority of one protein compared to another. In some embodiments of an analog cheese described in this specification pea protein is the predominant protein used. In any embodiment described in this specification, an analog cheese comprises a plant-based protein component comprised of pea protein and a second protein, wherein the pea protein is used in an amount of from about 50% to about 80% (wt % of the plant protein component), or from about 55% to about 75% of the (wt % of the analog cheese).

In any embodiment of an analog cheese described in this specification, a plant-based protein is provided as a pulse protein isolate having a protein content of at least about 75% (wt % of the pulse protein isolate), or from about 75% to 95% (wt % of the pulse protein isolate), or from about 75% to about 85% (wt % of the pulse protein isolate).

Any analog cheese described in this specification can be made from any embodiment of an analog cheese mass described in this specification.

In any embodiment, this specification discloses an analog cheese mass having fat in an amount of from about 10% to about 20% (wt % of the analog cheese mass), or from about 14% to 18%; plant-based protein in an amount of from about 10% to about 20% (wt % of the analog cheese mass), or from about 10% to about 15%, or from about 12% to about 15%; transglutaminase in an amount of from about 0.20% to about 0.50% (wt % of the analog cheese mass), or from about 0.25 to about 0.35% and a ripening agent, which for example may be, glucono delta-lactone or starter culture. In any embodiment described in this specification, an analog cheese mass further comprises bromelain. In embodiments bromelain can be provided to an analog cheese by use of non-flavored meat tenderizer, which can be used in an amount of about 0.25% to about 0.75% or from about 0.40% to about 0.60% (wt % of the analog cheese mass).

In various embodiments of an analog cheese mass, plant-based proteins are pulse proteins or proteins obtained from beans. In various embodiments a plant-based protein is a pea protein, mung bean protein, fava bean protein, lentil protein, chickpea protein or a potato protein and mixtures thereof. In any embodiment of an analog cheese mass, as described in this specification, comprises a mixture of plant-based protein. Use of mixtures includes mixtures of pea protein and fava bean protein or mixtures of pea protein and mung pea protein or mixtures or pea protein and potato protein, or mixtures of pea protein and fava bean protein and potato protein.

Within the described range of plant-based protein a mixture may use all proteins equally or use a majority of one protein compared to another. In some embodiments of an analog cheese mass described in this specification pea protein is the predominant protein used. In any embodiment described in this specification, an of an analog cheese mass comprises a plant-based protein component comprised of pea protein and a second protein, wherein the pea protein is used in an amount of from about 50% to about 80% (wt % of the protein component), or from about 55% to about 75% of the (wt % of the protein component).

In any embodiment of an analog cheese mass described in this specification, a plant-based protein is provided as a pulse protein isolate having a protein content of at least about 75% (wt % of the protein pulse isolate), or from about 75% to 95% (wt % of the pulse protein isolate), or from about 75% to about 85% (wt % of the pulse protein isolate).

In any embodiment described in this specification, of an analog cheese uses any suitable plant-based oil, including but not limited to coconut oil, palm, oil, sunflower oil, canola oil, vegetable oil, and mixtures thereof.

In some embodiments additional texturizing ingredients may be used to further adjust the hardness or texture of the analog cheese mass. Common texturizing agents include starch, in native, pregelatinized, and modified forms. Starch may be from any botanical starch, including but not limited to corn, tapioca, potato, pea, rice, sago, chickpea, lentil, fava bean, quinoa including high and low (or waxy) amylose variants. Starch may be provided as starch, or as a flour, including flours processed to have high or protein content relative to the unprocessed flour. Starches and flours may be hydrolyzed or thinned to improve gelling properties for example by shear, acid hydrolysis, oxidation, oxidative hydrolysis, enzymatic hydrolysis. Starch may also be modified to improve process tolerance such as by etherification or esterification or thermal inhibition. Examples of modified starch further include phosphate crosslinked starch, adipate crosslinked starch, hydroxypropylated starch, acetylated starch, starch citrates, and succinate modified starch including octenylsuccinate (OSA) modified starches.

Other texturizing agents useful in embodiments of the disclosed analog cheese mass include hydrocolloids including gums and fibers including but not limited to xanthan gum, guar gum, acacia gum, locust bean gum, carrageenan, pectin, agar, modified celluloses such as carboxymethylcellulose (CMC) or HPMC, and mixtures thereof.

An aspect of the technology disclosed in this specification is the ability to make high-protein, hard analog cheese without the use of starch, hydrocolloid, fiber, and mixtures thereof. As such in any embodiment disclosed in this specification, analog cheese masses include those that do not comprise an added starch, hydrocolloid, fiber or mixture thereof.

In various embodiments, analog cheese mass, as described in this specification includes a starter culture. In various embodiments, a starter culture useful for making an analog cheese mass comprises an acid forming bacteria, or a lactic acid forming bacteria. In various embodiments a starter culture comprises one or more bacteria species including but not limited to Streptococcus thermophilus, Lactobacillus bulgaricus, Lactobacillus acidophilus, Lactobacillus paracasei, and Bifidobacterium animalis and mixtures thereof.

Analog cheese mass, as described in this specification may also include, salts, acidulants and other flavoring ingredients commonly used in analog cheese masses.

The analog cheese masses described in this specification is useful to make any embodiment of an analog cheese described in this specification.

The technology disclosed in this specification also pertains to a method of making an analog cheese. In any embodiment, a method of making an analog cheese includes the steps of obtaining a mixture of water, fat and a plant-based protein to form an emulsified fat blend; adding a ripening agent (which for example may be glucono delta-lactone or a starter culture) and a transglutaminase and optionally a glucose source to the emulsified fat blend to form an analog cheese mass; optionally adding additional ingredients to the analog cheese mass such as salt and bromelain; and pressing the cheese mass to form an analog cheese.

In embodiments the cheese mass is heated to make a homogenous cheese mass. In embodiments a heating step heats a mixture of fat, protein, and water for about 90° C. for about a minute for microbial control. The mass is then allowed to cool to about 40° C. before adding enzymes or starter cultures. In alternate embodiments, fat, protein, water and bromelain are mixed and allowed to sit for a time of from about 0.5 to about 2 hours or from about 1 to about 2 hours prior to heating, which inactivates the bromelain enzyme. Other embodiments include the steps of a) adding transglutaminase and one or more of starter culture and glucono delta-lactone to the heated and then cooled mixture of fat, water, and protein; b) allowing the mixture to rest for enough time for transglutaminase to crosslink proteins within the mass, for example from 1 to 24 hours or preferably at least 6 hours, or at least 8 hours, more preferably between 6 and 12 hours; and c) adding meat tenderizer (preferably containing bromelain) to the crosslinked mass.

In various embodiments, a method to make an analog cheese includes obtaining an emulsified fat blend having water in an amount of about 50% to about 70% (wt % analog cheese mass) or about 55% to about 65% (wt % of the analog cheese mass). In various embodiments, a method to make an analog cheese includes obtaining an emulsified fat blend having fat an amount of from about 10% to about 20% (wt % of the analog cheese mass), or from about 14% to 18% (wt % of the analog cheese mass). In various embodiments, a method to make an analog cheese includes obtaining an emulsified fat blend having a plant-based protein in an amount of from about 10% to about 20% (wt %), or from about 10% to about 15%, or from about 12% to about 15% (wt % of the analog cheese mass). In various embodiments, a method to make an analog cheese includes adding transglutaminase to an emulsified fat blend in an amount of from about 0.20% to about 0.50% (wt % of the analog cheese mass), or from about 0.25 to about 0.35% (wt % of the analog cheese mass). In various embodiments, a method to make an analog cheese includes adding monohydrate glucose to an emulsified fat blend in an amount of from about 2% to about 6% (wt % of the analog cheese mass) or from about 3% to about 5% (wt % of the analog cheese mass). In various embodiments, a method of making an analog cheese includes adding a bromelain to an analog cheese mass in amounts up to about 0.65% (wt % of the analog cheese mass) or up to about 0.50% (wt % of the analog cheese mass). In embodiments, bromelain can be added to an analog cheese mass by using a non-flavored meat tenderizer in an amount of about 0.25% to about 0.75% or from about 0.40% to about 0.60% (wt % of the analog cheese mass). In various embodiments salt is added in an amount between 1% and 3% (wt % of the analog cheese mass).

In any embodiment described in this specification, an analog cheese mass is pressed to form an analog cheese. The analog cheese mass may be pressed at a single pressure or using multiple pressures which may be increased in stepwise or ramped manner. In any embodiment of a method to make an analog cheese described in this specification an analog cheese mass is pressed at one or more pressures of from about 1 to about 5 bar or from about 2 to about 4 bar. In any embodiments an analog cheese mass is pressed at least once using a pressure of at least about 3 bar, or at least about 4 bar.

Any method described in this this specification is useful for obtaining an analog cheese using the ingredients. Such ingredients include but are not limited to plant-based proteins selected from the group including but not limited to pea protein, mung bean protein, fava bean protein, lentil protein, chickpea protein and mixtures. Such plant-based proteins may be mixtures of plant-based proteins including mixtures of pea protein and fava bean protein or mixtures of pea protein and mung pea protein or mixtures or pea protein and potato protein, or mixtures of pea protein and fava bean protein and potato protein. Additionally, such plant-based proteins may be pulse protein isolate having protein content of at least about 75% (wt % of the pulse protein isolate), or from about 75% to about 95% (wt % of pulse protein isolate), or from about 75% to about 85% (wt % of the pulse protein isolate).

Other ingredient useful in various embodiments of the method to make an analog cheese as described in this specification include but are not limited to plant-based oils including but not limited to coconut oil, palm, oil, sunflower oil, canola oil, vegetable oil, and mixtures thereof. Still other ingredient useful in various embodiments of the method to make an analog cheese as described in this specification include starter cultures including but not limited to acid forming bacteria, or a lactic acid forming bacteria. In some embodiments a starter culture comprises one more bacteria species including but not limited to Streptococcus thermophilus, Lactobacillus bulgaricus, Lactobacillus acidophilus, Lactobacillus paracasei, and Bifidobacterium animalis and mixtures thereof.

In various embodiments, a method to make an analog cheese described in this specification does not include addition of an ingredient selected from the group consisting of modified starch, hydrocolloid, fiber, and mixtures thereof.

The methods described in this specification are suitable for making any analog cheese or analog cheese mass described in this specification.

The following definitions and comments are useful for interpreting the various embodiments of the technologies disclosed in this specification.

Reference in this specification to “an added ingredient selected from the group consisting of modified starch, hydrocolloid, fiber, and mixtures thereof” is to be understood in context of the use of plant-based protein materials that will typically comprise some amount of starch and fiber resulting from imperfections in the process used to isolate protein from the original milled material. As such, the term is to be understood as the addition of an ingredient comprising a starch, a fiber, a hydrocolloid or mixture thereof from a source other than the plant protein source.

Reference in this specification to “analog cheese” refers to a non-dairy food composition intended to mimic dairy cheese. The analog cheese described in this specification may mimic any target dairy cheese in texture and flavor, but in some embodiments analog cheese is intended to mimic semi-soft to hard cheese including for example commercially available Cheddar cheese sticks or cubes.

Reference in this specification to “bromelain” refers to a class of proteases that can be categorized as Enzyme Commission (E.C.) Numbers 3.4.22.32 or 3.4.22.33. Bromelain is commonly used in meat tenderizers which may be used to provide bromelain in any embodiment disclosed in this specification.

Reference in this specification to “modified starch” means a starch that has been modified chemically, enzymatically or physically in a way that does not just gelatinize the starch.

Reference in this specification to a “pulse protein isolate” means a composition having at least about 75% plant-based protein that is obtained from a pulse (for example a pea, lentil, chickpea, or fava bean) that. Pulse protein isolates are commercially available from various sources.

Reference in this specification to a “ripening agent” means a chemical, bacterium, or other agent that ripens cheese, and reference to “cheese ripening” means a process where changes occur in a cheese resulting in the development of flavor, texture, and aroma in the matured product. Ripening agents include but are not limited to glucono delta-lactone and starter culture.

Reference in this specification to “starter culture” means any bacteria culture useful to transform an oil-in-water emulsion of fat and plant-based protein into an analog cheese mass. Starter cultures may be the same as those used in conventional dairy cheese making processes or may comprise bacteria selected to work in a non-dairy system to make an analog cheese. Starter cultures are commercially available from various sources. In various embodiments a starter culture comprises one or more bacteria species including but not limited to Streptococcus thermophilus, Lactobacillus bulgaricus, Lactobacillus acidophilus, Lactobacillus paracasei, and Bifidobacterium animalis and mixtures thereof

Reference in this specification to “transglutaminase” means any one of a class of enzymes that catalyze the formation of an isopeptide bond between the γ-carboxamide groups of glutamine residue side chains and the s-amino groups of lysine residue side chains with subsequent release of ammonia. Transglutaminase can be categorized as Enzyme Commission (“E.C.”) Number 2.3.2.13.

Use of “about” to modify a number is meant to include the number recited plus or minus 10%. Where legally permissible recitation of a value in a claim means about the value. Use of about in a claim or in the specification is not intended to limit the full scope of covered equivalents.

Recitation of the indefinite article “a” or the definite article “the” is meant to mean one or more unless the context clearly dictates otherwise.

While certain embodiments have been illustrated and described, a person with ordinary skill in the art, after reading the foregoing specification, can effect changes, substitutions of equivalents and other types of alterations to the methods, and of the present technology. Each aspect and embodiment described above can also have included or incorporated therewith such variations or aspects as disclosed regarding any or all the other aspects and embodiments.

The present technology is also not to be limited in terms of the aspects described herein, which are intended as single illustrations of individual aspects of the present technology. Many modifications and variations of this present technology can be made without departing from its spirit and scope, as will be apparent to those skilled in the art. Functionally equivalent methods within the scope of the present technology, in addition to those enumerated herein, will be apparent to those skilled in the art from the foregoing descriptions. Such modifications and variations are intended to fall within the scope of the appended claims. It is to be understood that this present technology is not limited to methods, conjugates, reagents, compounds, compositions, labeled compounds or biological systems, which can, of course, vary. All methods described herein can be performed in any suitable order unless otherwise indicated herein or otherwise clearly contradicted by context. It is also to be understood that the terminology used herein is for the purpose of describing aspects only and is not intended to be limiting. Thus, it is intended that the specification be considered as exemplary only with the breadth, scope and spirit of the present technology indicated only by the appended claims, definitions therein and any equivalents thereof. No language in the specification should be construed as indicating any non-claimed element as essential.

The embodiments illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

In addition, where features or aspects of the disclosure are described in terms of Markush groups, those skilled in the art will recognize that the disclosure is also thereby described in terms of any individual member or subgroup of members of the Markush group. Each of the narrower species and subgeneric groupings falling within the generic disclosure also form part of the technology. This includes the generic description of the technology with a proviso or negative limitation removing any subject matter from the genus, regardless of whether the excised material is specifically recited herein.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member, and each separate value is incorporated into the specification as if it were individually recited herein.

### Aspects

The technology disclosed in this specification can be further understood with reference to the follow non-limiting aspects

In a first aspect, the technology disclosed in this specification pertains to an analog cheese comprising fat; and a crosslinked plant-based protein.

In a second aspect, the technology disclosed in this specification pertains to the analog cheese of the first aspect further comprising transglutaminase.

In a third aspect, the technology disclosed in this specification pertains to the analog cheese of the first or second aspects further comprising a protease enzyme; optionally wherein the protease enzyme is bromelain.

In a fourth aspect, the technology disclosed in this specification pertains to the analog cheese of any one of the first to third aspects having a hardness of from about 3000 g to about 14,000 g.

In a fifth aspect, the technology disclosed in this specification pertains to the analog cheese of any one of the first to fourth aspects having a hardness selected from the group consisting of about 3,000 g to about 7,000 g, or from about 4,000 g to about 6,000 g; and about 8,000 g to about 14,000 g, or from about 9,000 g to about 12,000 g.

In a sixth aspect, the technology disclosed in this specification pertains to the analog cheese of any one of the first to fifth aspects wherein the analog cheese has a protein content of from about 5 g to about 7 g per 28 gram serving.

In a seventh aspect, the technology disclosed in this specification pertains to the analog cheese of any one of the first to sixth aspects that does not comprise an added ingredient selected from the group consisting of: starch, hydrocolloid, fiber, and mixtures thereof.

In an eighth aspect, the technology disclosed in this specification pertains to the analog the analog cheese of any one of the first to seventh aspects wherein the fat is a plant-based oil; optionally wherein the plant-based oil is selected from the group consisting of coconut oil, palm, oil, sunflower oil, canola oil, vegetable oil, and mixtures thereof.

In a ninth aspect, the technology disclosed in this specification pertains to the analog cheese of any one of the first to eighth aspects wherein the plant-based protein comprises a protein selected from the group consisting of pea protein, mung bean protein, fava bean protein, lentil protein, chickpea protein and mixtures thereof wherein, optionally, the plant-based protein comprises a mixture selected from the group consisting of (i) pea protein and fava bean protein; (ii) pea protein and mung pea protein; (iii) pea protein and potato protein; and (iv) pea protein and fava bean protein and potato protein.

In a tenth aspect, the technology disclosed in this specification pertains to the analog cheese of any one of the first to ninth aspects further having a property selected from the group consisting of a) wherein the fat is present in an amount of about 20% to about 30% (wt % of the analog cheese), or from about 23% to about 26%; b) wherein the plant-based protein in an amount of from about 15% to about 25% (wt % of the analog cheese), or from about 18% to about 21%; c) wherein a crosslinking agent (preferably transglutaminase) is present in an amount of from about 0.40% to about 0.60% (wt % of the analog cheese), or from about 0.45 to about or from about 0.48% to about 0.51%; d) wherein a meat tenderizer (preferably a bromelain containing the meat tenderizer) is present in an amount of up to about 0.85% (wt % by weight of the analog cheese), or from about 0.75% to about 0.85%, or from about 0.77% to about and e) combinations thereof.

In an eleventh aspect, the technology disclosed in this specification pertains to the analog cheese of any one of the first to tenth aspects wherein the plant-based protein is a plant protein component comprised of a pea protein and a second protein and wherein the pea protein is used in an amount of from about 50% to about 80% (wt % of the plant protein component) of the analog cheese, or from about 55% to about 75% of the (wt % of the protein component) of the analog cheese.

In a twelfth aspect, the technology disclosed in this specification pertains to the analog cheese of any one of the first to eleventh aspects wherein the plant-based protein is a pulse protein isolate having a protein content of at least about 75% (wt % of the pulse protein isolate), or from about 75% to about 95% (wt % by weight of the pulse protein isolate), or from about 75% to about 85% (wt % of the pulse protein isolate).

In a thirteenth aspect, the technology disclosed in this specification pertains to the analog cheese of any one of the first to twelfth aspects further comprising a ripening agent and wherein, optionally, the ripening agent is selected from the group consisting of starter culture and glucono delta-lactone.

In a fourteenth aspect, the technology disclosed in this specification pertains to an analog cheese mass comprising: a) fat in an amount of from about 10% to about 20% (wt % of the analog cheese mass), or from about 14% to about 18% (wt % of the analog cheese mass); b) plant-based protein in an amount of from about 10% to about 20% (wt % of the analog cheese mass), or from about 10% to about 15%, or from about 12% to about 15% (wt % of the analog cheese mass); c) transglutaminase in an amount of from about 0.20% to about 0.50% (wt % of the analog cheese mass), or from about 0.25 to about 0.35% (wt % of the analog cheese mass); and d) a ripening agent.

In a fifteenth aspect, the technology disclosed in this specification pertains to the analog cheese mass of fourteenth aspect further comprising a protease enzyme, wherein, optionally, the protease enzyme is bromelain.

In a sixteenth aspects, the technology disclosed in this specification pertains to the analog cheese mass of the fourteenth or fifteenth aspects wherein the fat is a plant-based oil, wherein, optionally, the fat is a plant-based oil selected from the group consisting of coconut oil, palm, oil, sunflower oil, canola oil, vegetable oil, and mixtures thereof.

In a seventeenth aspect, the technology disclosed in this specification pertains to the analog cheese of any one of the fourteenth to sixteenth aspects wherein the plant-based protein comprises a protein selected from the group consisting of pea protein, mung bean protein, fava bean protein, lentil protein, chickpea protein and mixtures thereof; wherein, optionally, the plant-based protein comprises a mixture selected from the group consisting of (i) pea protein and fava bean protein; (ii) pea protein and mung pea protein; (iii) pea protein and potato protein; and (iv) pea protein and fava bean protein and potato protein.

In an eighteenth aspect, the technology disclosed in this specification pertains to the analog cheese of any one of the fourteenth to the seventeenth aspects wherein the plant-based protein component comprises pea protein and a second protein, wherein the pea protein is used in an amount of from about 50% to about 80% (wt % of the protein component), or from about 55% to about 75% of the (wt % of the protein component).

In a nineteenth aspect, the technology disclosed in this specification pertains to the analog cheese mass of any one of the fourteenth to eighteenth aspects wherein the plant-based protein is a pulse protein isolate having a protein content of at least about 75% (wt %), or from about 75% to 95% (wt %), or from about 75% to about 85% (wt %).

In a twentieth aspect, the technology disclosed in this specification pertains to the analog cheese mass of any one of the fourteenth to nineteenth aspects wherein the ripening agent is selected from the group consisting of starter culture and glucono delta-lactone.

In a twenty-first aspect, the technology disclosed in this specification pertains to the analog cheese mass of any one of the fourteenth to twentieth aspects that does not comprise an added ingredient selected from the group consisting of: modified starch, hydrocolloid, fiber, and mixtures thereof.

In a twenty-second the technology disclosed in this specification pertains to a method of making an analog cheese comprising: a) obtaining a mixture of water, fat and a plant-based protein to form an emulsified fat blend; b) adding a ripening agent and transglutaminase to the emulsified fat blend in order to form an analog cheese mass; c) pressing the analog cheese mass to form an analog cheese.

In a twenty-third aspect, the technology disclosed in this specification pertains to the method of the twenty-second aspect further comprising adding an ingredient to the analog cheese mass selected from the group consisting of: (i) salt; (ii) a protease enzyme, wherein, optionally, the protease enzyme is bromelain; and (iii) mixtures thereof.

In a twenty-fourth aspect, the technology disclosed in this specification pertains to the method of the twenty-second or twenty-third aspects wherein the analog cheese mass is pressed at a pressure of from about 1 to about 5 bar or from about 2 to about 4 bar, and wherein, optionally the analog cheese mass is pressed at least once at a pressure of at least about 3 bar, or at least about 4 bar.

In a twenty-fifth aspect, the technology disclosed in this specification pertains to the method of any one of the twenty-second to twenty-fourth aspects wherein the emulsified fat blend further comprises glucose in an amount of from about 2% to about 6% (wt % by weight of the cheese mass) or from about 3% to about 5% (wt % by weight of the cheese mass).

In a twenty-sixth aspect, the technology disclosed in this specification pertains to the method of any one of the twenty-second to twenty-fifth aspects wherein the water is in amount of about 50% to about 70% (wt % by weight of the cheese mass) or about 55% to about 65% (wt % by weight of the cheese mass).

In a twenty-seventh aspect, the technology disclosed in this specification pertains to the method of any one of the twenty-second to twenty-sixth aspects wherein the fat is in an amount of from about 10% to about 20% (wt % by weight of the cheese mass), or from about 14% to about 18% (wt % by weight of the cheese mass).

In a twenty-eighth aspect, the technology disclosed in this specification pertains to any one of the twenty-second to twenty-seventh aspects wherein the plant-based protein is in an amount of from about 10% to about 20% (wt % by weight of the cheese mass), or from about 10% to about 15%, or from about 12% to about 15% (wt % by weight of the cheese mass).

In a twenty-ninth aspect, the technology disclosed in this specification pertains to any one of the twenty-second to twenty-eighth aspects wherein the transglutaminase is in an amount of from about 0.20% to about 0.50% (wt % by weight of the cheese mass), or from about 0.25% to about 0.35% (wt % by weight of the cheese mass).

In a thirtieth aspect, the technology disclosed in this specification pertains to any one of the twenty-second to twenty-ninth aspects further comprising a protease enzyme, wherein the protease enzyme is in an amount of up to about 0.65% (wt % by weight of the cheese mass), or up to about 0.50% (wt % by weight of the cheese mass).

In a thirty-first aspect, the technology disclose in this specification pertains to any one of the twenty-second to thirtieth aspects wherein a) the plant-based protein is provided by a pulse protein isolate selected from the group consisting of pea protein, mung bean protein, fava bean protein, lentil protein, chickpea protein and mixtures thereof; and wherein, optionally, the pulse protein isolate has a protein content of at least about 75% (wt % of the pulse protein isolate), or from about 75% to about 95% (wt % of the pulse protein isolate), or from about 75% to about 85% (wt % of the pulse protein isolate); and b) the fat is a plant-based oil selected from the group consisting of coconut oil, palm, oil, sunflower oil, canola oil, vegetable oil, and mixtures thereof; c) and any combination of a and b.

In a thirty-second aspect, the technology disclose in this specification pertains to the method of any one of the twenty-second to thirty-first aspects wherein the ripening agent the ripening agent is selected from the group consisting of starter culture and glucono delta-lactone.

In a thirty-third aspect, the technology disclosed in this specification pertains to the method of any one of the twenty-second to thirty-second aspects wherein bromelain is added either during step a) or between steps b) and c).

In a thirty-fourth aspect, the technology disclosed in this specification pertains to the method of any one of the twenty-second to thirty-third aspects wherein bromelain is added during step a), and wherein the method further comprises, between steps a) and b), allowing the emulsified fat blend with added the bromelain to rest for about 0.5 to about 2 hours, and heating the blend to inactivate the bromelain.

In a thirty-fifth aspect, the technology disclosed in this specification pertains to the method of any one of the twenty-second to thirty-fourth aspects further comprising in step b) allowing the analog cheese mass to rest for about 1 to about 24 hours, or for more than about 6 hours, or for more than about 8 hours, or for about 6 to about 12 hours, then adding bromelain to the analog cheese mass.

In a thirty-sixth aspect, the technology disclosed in this specification pertains to the method of any one of the twenty-second to thirty-fifth aspect wherein the method does not comprise adding an ingredient selected from the group consisting of: modified starch, hydrocolloid, fiber, and mixtures thereof

In a thirty-seventh aspect, the technology disclosed in this specification pertains to an analog cheese as described in any foregoing claim obtainable by or obtained by an analog cheese mass described in any foregoing aspect.

In a thirty-eighth aspect, the technology disclosed in this specification pertains to an analog cheese as described in any foregoing claim obtainable by or obtained by a method as described in any foregoing aspect.

In a thirty-ninth aspect, the technology disclosed in this specification pertains to an analog cheese mass as described in any foregoing claim useful for making an analog cheese as described in any foregoing claim aspect

In a fortieth aspect, the technology disclosed in this specification pertains to a method as described in any foregoing claim wherein the method makes an analog cheese as described in any foregoing aspect.

In a forty-first aspect, the technology disclosed in this specification pertains to use of one or more of transglutaminase and bromelain in an analog cheese or analog cheese mass, or in a method of making an analog cheese or analog cheese mass as described in any foregoing claim.

In a forty-second aspect, the technology disclosed in this specification pertains to an analog cheese comprising: a. a fat in an amount of about 20% to about 30% (wt % of the analog cheese), or from about 23% to about 26%; and b. a crosslinked plant-based protein in an amount of from about 15% to about 25% (wt % of the analog cheese), or from about 18% to about 21%; wherein, optionally, the analog cheese further comprises transglutaminase in an amount of from about 0.40% to about 0.60% (wt % of the analog cheese), or from about 0.45 to about or from about 0.48% to about 0.51%; wherein has a hardness of from about 3000 g to about 14,000 g or a hardness selected from the group consisting of: i. about 3,000 g to about 7,000 g, or from about 4,000 g to about 6,000 g; and ii. about 8,000 g to about 14,000 g, or from about 9,000 g to about 12,000 g.

In a forty-third aspect, the technology disclosed in this specification pertains to the analog cheese of the forty-second aspect further comprising a protease enzyme in an amount of up to about 0.85% (wt % by weight of the analog cheese), or from about 0.75% to about 0.85%, or from about 0.77% to about 0.83%; wherein, optionally the protease enzyme is bromelain.

In a forty-fourth aspect, the technology disclosed in this specification pertains to the analog cheese of the forty-second or forty-third aspect that does not comprise an added ingredient selected from the group consisting of: modified starch, hydrocolloid, fiber, and mixtures thereof.

In a forty-fifth aspect, the technology disclosed in this specification pertains to the analog cheese of any one of the forty-second to forty-fourth aspects wherein the fat is a plant-based oil; wherein, optionally, the plant-based oil is selected from the group consisting of coconut oil, palm, oil, sunflower oil, canola oil, vegetable oil, and mixtures thereof.

In a forty-sixth aspect, the technology disclosed in this specification pertains to the analog cheese of any one of the forty-second to forty-fifth aspects wherein the plant-based protein comprises a protein selected from the group consisting of potato protein, pea protein, mung bean protein, fava bean protein, lentil protein, chickpea protein and mixtures thereof; wherein, optionally, the plant-based protein is a plant-based protein component comprising a mixture of plant proteins selected from the group consisting of (i) pea protein and fava bean protein; (ii) pea protein and mung pea protein; (iii) pea protein and potato protein; and (iv) pea protein and fava bean protein and potato protein; wherein, optionally, the plant-based protein is a plant protein component comprised of a pea protein and a second protein and wherein the pea protein is used in an amount of from about 50% to about 80% (wt % of the plant protein component) of the analog cheese, or from about 55% to about 75% of the (wt % of the protein component) of the analog cheese.

In a forty-seventh aspect, the technology disclosed in this specification pertains to the analog cheese of any one of the forty-second to forty-seventh aspects further comprising a ripening agent and wherein, optionally, the ripening agent is selected from the group consisting of starter culture and glucono delta-lactone.

In a forty-eighth aspect, the technology disclosed in this specification pertains to an analog cheese mass comprising: a. a fat in an amount of from about 10% to about 20% (wt % of the analog cheese mass), or from about 14% to about 18% (wt % of the analog cheese mass); a plant-based protein in an amount of from about 10% to about 20% (wt % of the analog cheese mass), or from about 10% to about 15%, or from about 12% to about 15% (wt % of the analog cheese mass); and transglutaminase in an amount of from about 0.20% to about 0.50% (wt % of the analog cheese mass), or from about 0.25 to about 0.35% (wt % of the analog cheese mass); optionally, a ripening agent, which, optionally, is selected from the group consisting of starter culture and glucono delta-lactone; and optionally a protease enzyme, wherein, optionally, the protease enzyme is bromelain.

In a forty-ninth aspect the technology disclosed in this specification pertains to the analog cheese mass of the forty-eighth aspect wherein the fat is a plant-based oil, wherein, optionally, the fat is a plant-based oil selected from the group consisting of coconut oil, palm, oil, sunflower oil, canola oil, vegetable oil, and mixtures thereof.

In a fiftieth aspect, the technology disclosed in this specification pertains to the analog cheese of the forty-eighth or forty-ninth aspects wherein the plant-based protein comprises a protein selected from the group consisting of potato protein, pea protein, mung bean protein, fava bean protein, lentil protein, chickpea protein and mixtures thereof; wherein, optionally, the plant-based protein is a plant-based protein component comprising a mixture of plant-based proteins selected from the group consisting of (i) pea protein and fava bean protein; (ii) pea protein and mung pea protein; (iii) pea protein and potato protein; and (iv) pea protein and fava bean protein and potato protein; wherein, optionally, the plant-based protein comprises is a plant-based protein component comprising pea protein and a second protein, wherein the pea protein is used in an amount of from about 50% to about 80% (wt % of the protein component), or from about 55% to about 75% of the (wt % of the protein component).

In a fifty-first aspect, the technology disclosed in this specification pertains to the analog cheese of any one of the forty-eighth to fiftieth aspects that does not comprise an added ingredient selected from the group consisting of: modified starch, hydrocolloid, fiber, and mixtures thereof.

In a fifty-second aspect, the technology disclosed in this specification pertains to a method of making an analog cheese comprising: a. obtaining a mixture of water, fat and a plant-based protein to form an emulsified fat blend; b. adding a ripening agent and transglutaminase to the emulsified fat blend in order to form an analog cheese mass; c. pressing the analog cheese mass to form an analog cheese wherein, optionally, the fat is in an amount of from about 10% to about 20% (wt % by weight of the cheese mass), or from about 14% to about 18% (wt % by weight of the cheese mass); wherein, optionally, the fat is a plant-based oil selected from the group consisting of coconut oil, palm, oil, sunflower oil, canola oil, vegetable oil, and mixtures thereof; wherein, optionally, the plant-based protein is in an amount of from about 10% to about 20% (wt % by weight of the cheese mass), or from about 10% to about 15%, or from about 12% to about 15% (wt % by weight of the cheese mass); wherein, optionally, the method of any one of claims 22 to 28 wherein the transglutaminase is in an amount of from about 0.20% to about (wt % by weight of the cheese mass), or from about 0.25% to about 0.35% (wt % by weight of the cheese mass); wherein, optionally, the ripening agent the ripening agent is selected from the group consisting of starter culture and glucono delta-lactone; and wherein, optionally, the method does not comprise a step of adding an ingredient selected from the group consisting of: modified starch, hydrocolloid, fiber, and mixtures thereof.

In a fifty-third aspect, the technology disclosed in this specification pertains to the method of the fifty-second aspect, further comprising adding a protease enzyme to either (i) the mixture of water, fat and plant based protein or (ii) to the emulsified fat blend prior to adding and allowing the ripening agent and transglutaminase; allowing the mixture or emulsified fat blend to rest for about 0.5 to about 2 hours; and heating the mixture or emulsified fat blend to inactivate the protease enzyme wherein, optionally, the protease enzyme is bromelain.

In a fifty-fourth aspect, the technology disclosed in this specification pertains to the method of the fifty-second or fifty-third aspect wherein the analog cheese mass is pressed at a pressure of from about 1 to about 5 bar or from about 2 to about 4 bar, and wherein, optionally the analog cheese mass is pressed at least once at a pressure of at least about 3 bar, or at least about 4 bar.

In a fifty-fifth aspect, the technology disclosed in this specification pertains to the method of any one of the fifty-second to fifty-fourth aspects further comprising mixing glucose with the water, to fat, and plant-based protein in an amount of from about 2% to about 6% (wt % by weight of the cheese mass) or from about 3% to about 5% (wt % by weight of the cheese mass) to obtain the emulsified fat blend.

In a fifty-sixth aspect, the technology disclosed in this specification pertains to the method of any one of the fifty-second to fifty-fifth aspects wherein the water is in amount of about 50% to about 70% (wt % by weight of the cheese mass) or about 55% to about 65% (wt % by weight of the cheese mass).

In a fifty-seventh aspect, the technology disclosed in this specification pertains to the method of any one of the fifty-second to fifty-sixth aspects further comprising adding a protease enzyme, in an amount of up to about 0.65% (wt % by weight of the cheese mass), or up to about (wt % by weight of the cheese mass) to the emulsified fat blend.

In a fifty-eighth aspect, the technology disclosed in this specification pertains to the method of any one of the fifty-second to fifty-seventh aspects wherein the plant-based protein selected from the group consisting of potato protein, pea protein, mung bean protein, fava bean protein, lentil protein, chickpea protein and mixtures thereof; wherein, optionally, the plant-based protein is a plant protein component comprising a mixture of proteins selected from the group consisting of (i) pea protein and fava bean protein; (ii) pea protein and mung pea protein; (iii) pea protein and potato protein; and (iv) pea protein and fava bean protein and potato protein; wherein, optionally, the plant-based protein is a mixture of plant protein component comprised of a pea protein and a second protein and wherein the pea protein is used in an amount of from about 50% to about 80% (wt % of the plant protein component) of the analog cheese, or from about 55% to about 75% of the (wt % of the protein component) of the analog cheese.

In a fifty-ninth aspect, the technology disclosed in this specification pertains to the method of any one of the fifty-second to fifty-eighth aspects further comprising in step b) allowing the analog cheese mass to rest for about 1 to about 24 hours, or for more than about 6 hours, or for more than about 8 hours, or for about 6 to about 12 hours, then adding bromelain to the analog cheese mass.

In a sixtieth aspect, the technology disclosed in this specification pertains an analog cheese as described in any foregoing claim obtainable by or obtained by a method as described in any foregoing claim.

In a sixty-first aspect, the technology disclosed in this specification pertains to use of transglutaminase in an analog cheese or analog cheese mass, in a method to make an analog cheese, or in a method to make an analog cheese mass as described in any foregoing claim.

The technology disclosed in this specification can be further understood with reference to the following examples, which are not intended to be limiting in any way.

### Example 1—Analog Cheese Made Using Transglutaminase

Protein content in the analog cheese is between about 5 and about 7 g protein per 28 g serving size

TABLE 1
Analog Cheese Mass Formulation

| | Percentage |
|---|---|
| Ingredients | (wt %) |
| Water | 64 |
| Vegetable oil (70% coconut oil and | 16 |
| 30% sunflower oil) | |
| Pea protein isolate (80% w/w) | 13 |
| Mung bean protein isolate | 3 |
| Monohydrate dextrose | 4 |
| Total | 100 |

Fat, mung bean protein and water was mixed at 7000 rpm for 10 minutes to form an emulsified fat blend. Pea protein and dextrose was added to the fat blend and further mixed to obtain a homogenous mixture. The homogenous mixture was heated to 90° C. for about a minute for microbial control and allowed to cool to 40° C. Glucono-delta lactone (1% by weight of the mass) and transglutaminase (0.31% by weight of the mass) were then added, and the mixture set overnight to form an analog cheese mass. Formed mass was cut and the curd was allowed rest for minutes. In some samples, bromelain was added during healing by adding 0.5% (wt % of the mass) meat tenderizer (containing bromelain). The temperature of the analog cheese mass was maintained at 40° C. for 40 minutes. The mass was then pressed in three stages at 30-40 psi (about 2 to 2.75 bar) pressure to allow serum to drain off. At 50-60 psi (about 3.4 to about 4.1 bar) pressure till serum separation stops, and overnight at 70 psi (about 4.8 bar). Mass was surface dried with turned over for even drying on both sides for 1-3 days. The mass was vacuum packed and stored at refrigerated temperature (about 4° C.) until measured for hardness.

Obtained analog cheese had a protein content of about 5 to about 7 g protein per 28 g serving size. The hardness of the analog cheese mass was measured by TA.XT as follows: Analog cheese sample core of 17-18 mm height maintained at refrigeration temperature was analyzed using Stable Micro Systems Texture Analyzer TAXTPlus with a 30 kg load cell and diameter probe using TPA Compression test. Hardness value (measured in g) is the maximum force of the 1^{st} penetration measured by the system. Samples were analyzed using a test speed (pre and post as well) at 8 mm/second, target mode-distance, distance-10 mm, time-2 seconds, Trigger force-10 g. The analog cheese mass was measured to have a hardness of about g (10,187 g) without use of bromelain, or about 5000 g (5199 g) with use of bromelain.

### Example 2—Analog Cheese Made without Transglutaminase Using Starch and Hydrocolliods

A comparable analog cheese having a hardness of about 5000 grams made without the use of transglutaminase is provided in Table 2.

TABLE 2
Comparative Analog Cheese Made Without Transglutaminase

| | Percentage |
|---|---|
| Ingredients | (wt %) |
| Water | 55.81 |
| Coconut Oil (refined) | 21.75 |
| Fava Bean Protein Concentrate | 4.17 |
| Pea Protein Isolate | 11.22 |
| TICALOID ® 620 (gum mix) | 0.75 |
| (Ingredion, Incorporated) | |
| Starch | 4.00 |
| Lactic Acid | 1.30 |
| Salt | 1.00 |
| Total | 100.00 |

Notably the formula of table 2 uses added starch and gum to help provide firm structure to the cheese. High usage of gums and starch can be problematic when looking to make harder analog cheese (hardness of greater than about 5,000 g) because the starch and gum may interfere with the emulsion stability leading to oil separation.

1. An analog cheese comprising:
a. a fat in an amount of about 20% to about 30% (wt % of the analog cheese); and
b. a crosslinked plant-based protein in an amount of from about 15% to about 25% (wt % of the analog cheese);
wherein has a hardness of from about 3000 g to about 14,000 g
wherein, the analog cheese further comprises transglutaminase in an amount of from about 0.40% to about 0.60% (wt % of the analog cheese). and
wherein the analog cheese further comprises a protease enzyme in an amount of up to about 0.85% (wt % by weight of the analog cheese).

2. The analog cheese of claim 1 further comprising a protease enzyme in an amount from about 0.75% to about 0.85%.

3. The analog cheese of claim 1 that does not comprise an added ingredient selected from the group consisting of: modified starch, hydrocolloid, fiber, and mixtures thereof.

4. The analog cheese of claim 1 wherein the fat is a plant-based oil selected from the group consisting of coconut oil, palm, oil, sunflower oil, canola oil, vegetable oil, and mixtures thereof.

5. The analog cheese of claim 1 wherein the plant-based protein comprises a protein selected from the group consisting of potato protein, pea protein, mung bean protein, fava bean protein, lentil protein, chick-pea protein and mixtures thereof.

6. The analog cheese of claim 1 further comprising a ripening agent selected from the group consisting of starter culture and glucono delta-lactone.

7. An analog cheese mass comprising:
a. fat in an amount of from about 10% to about 20% (wt % of the analog cheese mass),
b. plant-based protein in an amount of from about 10% to about 20% (wt % of the analog cheese mass);
c. transglutaminase in an amount of from about 0.20% to about 0.50% (wt % of the analog cheese mass);
and
e. a protease enzyme, wherein, optionally, the protease enzyme is bromelain.

8. The analog cheese mass of claim 7 wherein the fat is a plant-based oil, selected from the group consisting of coconut oil, palm, oil, sunflower oil, canola oil, vegetable oil, and mixtures thereof.

9. The analog cheese of claim 7 wherein the plant-based protein comprises a protein selected from the group consisting of potato protein, pea protein, mung bean protein, fava bean protein, lentil protein, chick-pea protein and mixtures thereof.

10. The analog cheese mass of claim 7 that does not comprise an added ingredient selected from the group consisting of: modified starch, hydrocolloid, fiber, and mixtures thereof.

11. A method of making an analog cheese comprising:
a. obtaining a mixture of water, fat and a plant-based protein to form an emulsified fat blend;
b. adding a ripening agent and transglutaminase to the emulsified fat blend in order to form an analog cheese mass;
c. pressing the analog cheese mass to form an analog cheese.

12. The method of claim 11 further comprising:
a. adding a protease enzyme to either (i) the mixture of water, fat and plant based protein or (ii) to the emulsified fat blend prior to adding and allowing the ripening agent and transglutaminase;
b. allowing the mixture or emulsified fat blend to rest for about 0.5 to about 2 hours;
c. and heating the mixture or emulsified fat blend to inactivate the protease enzyme
wherein, optionally, the protease enzyme is bromelain.

13. The method of claim 11 wherein the analog cheese mass is pressed at a pressure of from about 1 to about 5 bar.

14. The method of claim 11 further comprising mixing glucose with the water, to fat, and plant-based protein in an amount of from about 2% to about 6% (wt % by weight of the cheese mass).

15. The method of claim 11 wherein the water is in amount of about 50% to about 70% (wt % by weight of the cheese mass).

16. The method of claim 11 further comprising adding a protease enzyme, in an amount of up to about 0.65% (wt % by weight of the cheese mass.

17. The method of claim 11 wherein the plant-based protein selected from the group consisting of potato protein, pea protein, mung bean protein, fava bean protein, lentil protein, chickpea protein and mixtures thereof.

18. The method of claim 11 further comprising in step b) allowing the analog cheese mass to rest for about 1 to about 24 hours then adding bromelain to the analog cheese mass.

19. (canceled)

20. (canceled)

21. The analog cheese of claim 1 wherein the plant-based protein is a plant protein component comprised of a pea protein and a second protein and wherein the pea protein is used in an amount of from about 50% to about 80% (wt % of the plant protein component).
